(19) United States
(12) Patent Application Publication
(10) Pub. No.: US 2014/0308020 A1
(43) Pub. Date: Oct. 16, 2014

(54) MARITAL AID

(71) Applicant: Michael F. Seeger, Minneapolis, MN (US)

(72) Inventor: Michael F. Seeger, Minneapolis, MN (US)

(21) Appl. No.: 14/248,619

(22) Filed: Apr. 9, 2014

Related U.S. Application Data
(60) Provisional application No. 61/812,388, filed on Apr. 16, 2013.

(51) Int. Cl. G11B 27/10; G11B 27/034; H04N 9/87

(52) U.S. Cl. CPC G11B 27/105; H04N 9/87; G11B 27/034
USPC 386/241

(57) ABSTRACT

Systems, methods, and computer readable media for superimposing an image of an individual onto that of an actor are disclosed. A system may comprise a computer-readable medium and a logic stored on the computer readable medium. The logic may comprise instructions that, when executed by a processor, cause the processor to perform operations including: matching a video frame with a head shot based on one or more common tags shared by the video frame and the head shot; and superimposing the head shot on a body within the video frame.

### RELATED APPLICATIONS

Priority is claimed to U.S. Provisional Application Ser. No. 61/812,388, filed Apr. 16, 2013, entitled a “Marital Aid,” which is hereby incorporated by reference in its entirety.

### FIELD OF THE INVENTION

The present invention relates to marital aids. In particular, the present invention relates to improving marital relations using customized explicit videos.

### BACKGROUND OF THE INVENTION

Sexuality is a taboo subject, even among happily married couples. Despite being legal, explicit entertainment suffers from a negative reputation, possibly because it encourages fantasizing about strangers, thereby potentially harming existing relationships. However, sexually explicit media, including videos and audio, can be used as a tool to increase intimacy and depth of connection between couples. For instance, an individual traveling for a business meeting may miss the physical connection to his partner. Rather than using explicit entertainment to provide sexual relief, the individual may prefer a virtual fantasy with his partner. However, given the negative stigma towards explicit entertainment, people in relationships are typically unwilling to explore this realm, or are unable to overcome shyness and/or record one's self on video for a partner. Consequently, relationships suffer and couples exist with an imbalance of libido where one partner is greater in his/her desire for the sexual intimacy. This “imbalance” often creates unnecessary friction between partners as one may be consistently unsatisfied but very much attracted to their partner. Subsequently, the relationship establishes two roles: one as the unsatisfied and one as the unwilling partner. The unsatisfied partner has traditionally found solace in internet experiences with unknown 3^{rd} party non-engaged “partners. These actions are seen as “going outside” the relationship and inevitably lead to mistrust, secrecy and possibly divorce.

### SUMMARY OF THE INVENTION

Systems, methods, and computer readable media for superimposing an image of an individual onto an actor are disclosed. A system may comprise a computer-readable medium and a logic stored on the computer readable medium. The logic may comprise instructions that, when executed by a processor, cause the processor to perform operations including: matching a video frame with a head shot based on one or more common tags shared by the video frame and the head shot; and superimposing the head shot on a body within the video frame.

In other embodiments, the operations may include: calculating a first transition vector comprising a difference between a previous frame and a current frame of a first video of the actor; calculating a second transition vector comprising a difference between a previous frame and a current frame of a second video of an individual; selecting at least a portion of the second video based, at least in part, on a matching of the first transition vector with the second transition vector; and superimposing the selection of at least a portion of the second video onto the first video.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 shows a system for executing the operations disclosed herein, according to an example embodiment of the present disclosure;

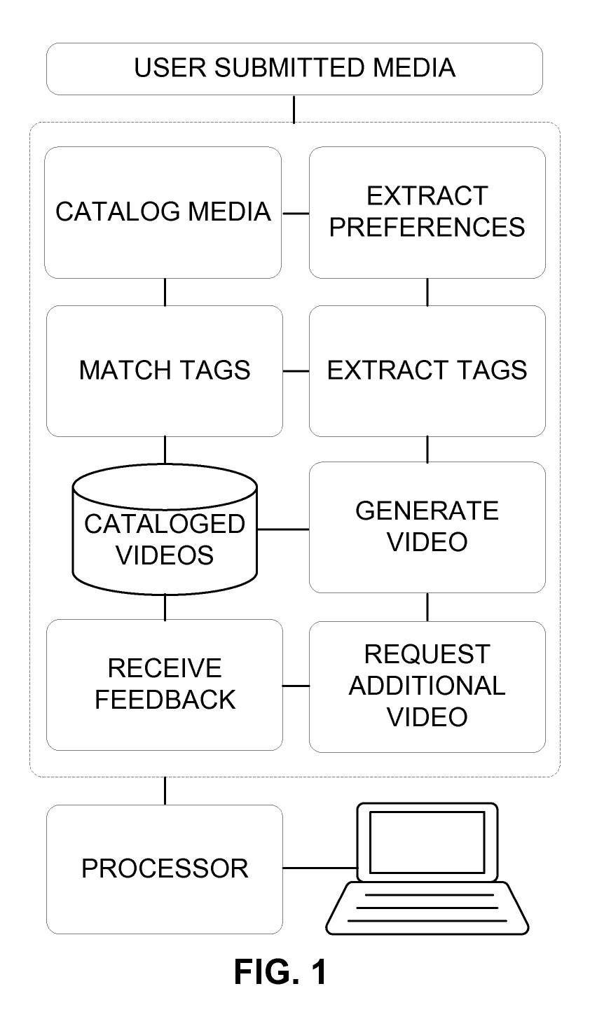

FIGS. 2A-2D show headshots with tags, according to an example embodiment of the present disclosure; and

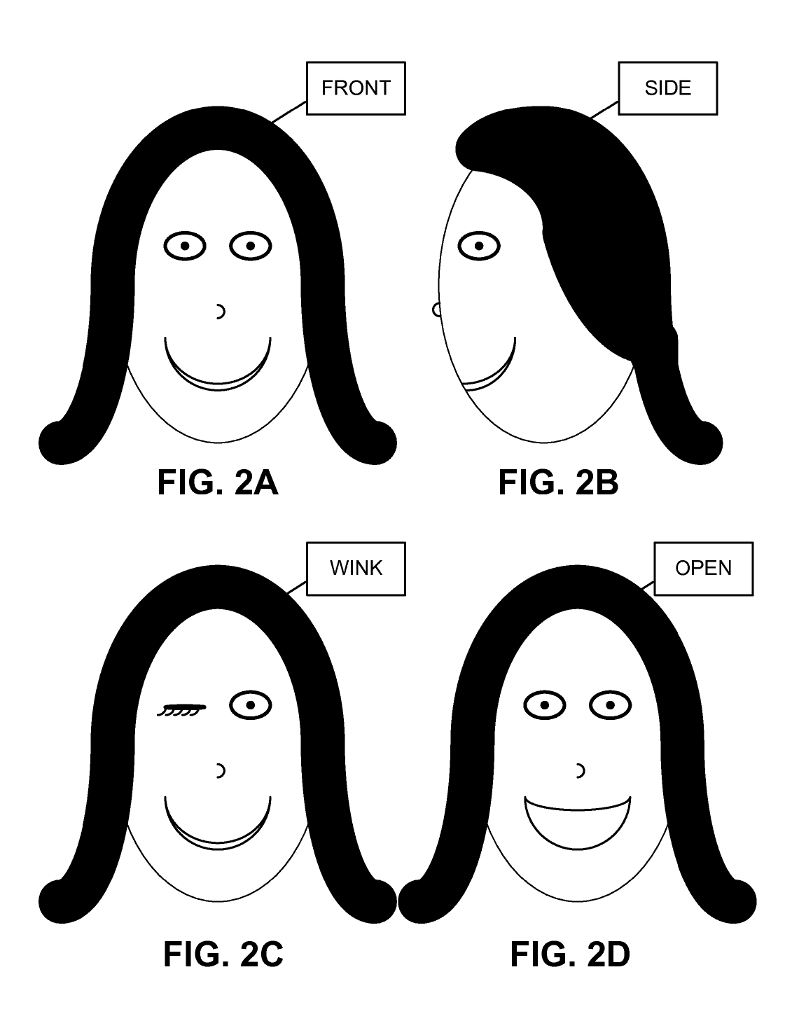

FIGS. 3A-3B show a superimposition of a headshot on a video frame based on matching common tags, according to an example embodiment of the present disclosure.

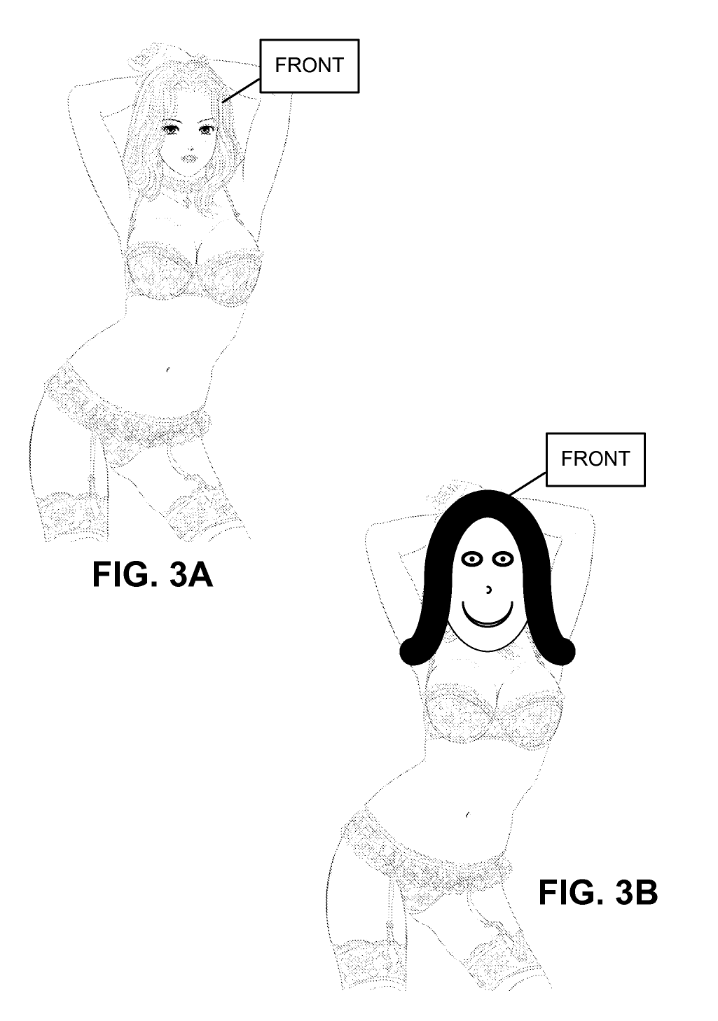

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical video systems, processes, and materials. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention enables ordinary individuals to create a real-life persona(s), or a virtual fantasy character, for use in the creation of personalized, explicit videos. This would result in a reduction or elimination of all strain on relationships or marriages that typically arise from the use of online explicit entertainment by one partner, and the mistrust, secrecy, and pain caused to that relationship by such use. An individual may provide a plurality of photos and/or videos of him/her, along with several preferences related to the video that he/she would like to create. Disclosed systems, methods, and computer-program products can create real-life 1st person “characters” of the individual, and place this character in a series of short videos or vignettes with the individual partner to create intimate online session(s) that include both partners and may or may not introduce any outside persons or outside engagement, hence eliminating the pain and trust breakdown that outside engagements result in.

The photos/videos may be tagged with specific attributes. These attributes may be matched to previously recorded vignettes, and face or body shots submitted by the individual may be superimposed over an actor or stock footage in the vignette, thereby simulating an act being performed by the individual. The resulting product allows couples to explore sexual stories and fantasies without any infidelity, ill feelings, secrecy, or risk of sexually transmitted diseases, all at a pace that accounts for any imbalance in libido, experience or sexual maturity between the partners.

“Character” updates may be added to reflect desired attributes or scenarios, as the individual aims to please his/her partner without the feeling of inadequacy. Couples would be the “stars” of their own password-protected videos for future use/viewing. This enables a joint, private, legal, and safe environment for couples to introduce exciting “date nights” into unfulfilling relationships, experiment with fantasy role-playing scenarios without the introduction of 3rd parties, or permit a more sexually driven partner the opportunity to express him/herself without the potential for infidelity or guilt in participating in sexual activity without the other partner's participation. The inventive methods and products would offer a means for providing online or offline video-based pleasure for all partners in a relationship, and would benefit all couples in long distance relationships, such as troops deployed in other countries, couples who have seen the passion lessen, or couples in relationships in need of help with an imbalance in sexual desire between partners. The disclosed invention does away with mistrust or the “double life” dynamic associated with couples when explicit entertainment is not a mutually agreed upon component of the relationship.

In exemplary embodiments, an individual that wishes to participate in such a virtual video may capture/photograph, or make available a repository of, a series of shots or videos of him/herself such that these shots can be placed or superimposed on an existing explicit stock video. The existing explicit video may or may not be filmed with such a superimposition in mind. For instance, professional explicit actors may be filmed in front of a green screen, enabling efficient superimposition of the individual's face/body parts. Green suits or similar tools may also be used by either the individual or the actors, depending upon the type of superimposition.

The individual may film or photograph him/herself, or merely parts thereof, in various positions/actions/expressions. The individual may also record her voice saying various words/sentences, making sounds, or indicating various states of emotion or sensation. The individual may then submit these photographs and/or videos and sounds via mail or electronically, along with a selection of preferences for what type of video she wants to be in.

Such preferences may be indicated in the form of choices on a form, website, etc. In some embodiments, the 10 most commonly requested vignettes may be displayed as choices, along with an extra choice for the individual to specify a custom scenario. For instance, the individual would like to create a seductive strip-tease video for her husband, but is too shy or sexually inexperienced/reluctant, but by providing only face or headshots, the exemplary embodiment would enable superimposition of the headshots over an existing or custom-produced strip-tease video performed by a professional that leaves the couple with a ‘relationship specific’ final product. The result would be a ‘personalized’ video appearing to the viewer (in this case, the husband) as being a strip-tease performed by the wife. Other possible scenarios may be contemplated by those having ordinary skill in the art in light of this disclosure.

Additional characters, either virtual or real, may be added to the virtual video, depending upon the choices of the individual requesting the video. For instance, a “threesome” may be produced, including an actor having superimposed thereon a headshot of the individual, and a third person selected by the individual or the couple requesting the video. The third person may play the role of any common fantasy (i.e. a TV repairman, a nurse, babysitter, etc.) The benefit of this virtual video is that it enables such a fantasy scenario without necessarily involving uncomfortable intimacy with strangers that a similar but real situation may require. Alternatively, an existing video may be selected from a plurality of pre-existing explicit videos. Also alternatively, selections may be made by the viewer, rather than the contributor, of the video.

Disclosed embodiments involve tagging the received headshots/bodyshots/videos with specific tags or attributes, and then matching these tags with similar or identical tags attached to actors or models in the actual explicit video. For instance, a strip tease video may be filmed for the purpose of a superimposition. Specific times in the video may be tagged, such as ‘undressing”, “smiling”, “dancing”, “left camera angle”, “right camera angle”, and so on. Similarly, the individual customer's headshots/video clips may similarly be tagged. Determining a match between a “smiling” headshot submitted by the individual and a “smiling” model in a video may trigger a determination to superimpose the headshot over the video. The headshot may also be processed to fit the shape and size of a head of a model or actor in the video, resulting in a seamless experience for the viewer. The models/actors may be asked beforehand to perform commonly-requested actions in a generic fashion, with those actions being tagged as such, enabling more efficient matching of individual headshots/clips/sounds to the actions prior to superimposition.

The individual customer may also request desired clothes in a particular color/style. The individual customer may additionally submit pictures or videos of him/herself in particular outfits, such as a dress familiar to the viewer, birthday/Valentine's sexy lingerie, etc. Exemplary embodiments of the subject disclosure may subsequently match the received images with a vignette, such as the strip-tease vignette discussed above, with the submitted outfits superimposed upon the body prior to disrobing. As a result, the pre-nudity portions of the video may be the individual's clothes and body, and upon completely disrobing, the video seamlessly shifts to the body of the professional actor. This enables a peace of mind in the individual that there is no nude image of her/him being submitted to any entity, or that even exists, for that matter. Further, the individual/couple requesting the video may also submit (or be asked to submit) videos/images of themselves performing certain actions while dressed. Example embodiments may subsequently superimpose the couple's heads over the naked bodies of actors performing identical actions, based on matching tags as described herein. Moreover, since it is computer software that performs the receiving, extracting, matching, and video generation processes, this removes any insecurity in the mind of the individual that intimacy might be exposed to an unknown person.

A back-and-forth process may be initiated or requested. Such a back-and-forth process may enable customization and tweaking of the product, until the individual or couple customer reaches a point where they are satisfied with the video. Moreover, the customer's preferences and inhibitions may change over time, such that he continues to submit variations of faces, expressions, body shots, etc. Such a system may require a customer account accessible via a paid subscription, with limited numbers of submissions and video requests. The system may expand over time to enable filming of more types of vignettes by professional actors, depending upon the requests of paid subscribers, or may add to an existing library of pre-made and tagged explicit videos.

The system also allows for enhancements to an individual's body by, for instance, superimposing a professional actor or model's body parts over the individual's body parts. In some embodiments, such enhancements may be performed in real-time. For instance, a partner may be undressed via a webcam for another partner using the disclosed system. The disclosed system may superimpose particular body parts over the posing partner's body in real-time, such that the viewing partner gets a seamless experience of his partner having enhanced body parts.

In light of the foregoing, in addition to the use of common tags, embodiments of the disclosure may also employ the use of transition vector attributes to determine, for example frame by frame, or over group of successive frames by group of successive frames, aspects of the video of the actor. For example, for each transition between two frames or groups of frames, the system may calculate vectors of displacement, orientation, size, and transformation of various features or points on the body and face of the actor and individual. The system may use the displacement vectors, for example, to adapt a location of the picture or video of the individual which will replace the face of the actor in the recorded video. The orientation vectors may be used to adapt the orientation of the shots of the individual. The size vectors may be used to adapt the size differences between the frames, or groups of frames. In a similar fashion, the system may calculate vectors of displacement, orientation, size, and transformation for the individual.

Based on the transitions from frame to frame, or group of frames to group of frames of the video with the actor's face shown, the system may select particular shots or groups of particular shots of the individual to insert into the video. For example, from afore-discussed transition vector attributes of the actor, the system matches calculated transition vector attributes of the individual to effect an accurate superimposition of the face.

In light of the present disclosure, one of ordinary skill in the art would understand that the system can be employed real time, as well. That is, superimposition of shots of the individual's face may be performed on the fly during actual playback of the video. For example, typically, the time between successive frames in a video system is approximately 20 milliseconds. During this time, embodiments of the disclosure may determine the transition vector attributes between a former frame and a current frame of the actor, and automatically select the appropriate (e.g., best fit) transition vector attributes of the individual for superimposition.

The inventive systems and methods may be embodied as tangible non-transitory computer-readable program code stored on a computer-readable medium, such as a DVD, flash drive, or on a web server accessible via the Internet. The DVD may be bundled along with other software, a questionnaire, and other accessories into a make-at-home kit for the customer to review. The questionnaire may include selections for the various types of vignettes described herein, as well as any preferences related to level of explicitness, fantasy/role-playing setting, selections of additional actors to perform side roles, etc. A celebrity selection may be offered, with an option to add a celebrity's face to an actor's body. This creates a business opportunity for the celebrity to license their face or likeness to be superimposed on various explicit products. The kit may include an application to be installed onto a home computer. Alternatively or in addition, the customer may create an account on a web domain operated by the operator of the inventive system, and may specify preferences and submit photos/videos/sounds via a web interface. The web interface may be secure. These and other services may be offered as part of a tiered membership model, allowing different levels of access to vignettes, limited-time access, and offers to upgrade to a higher-paying account in order to be able to access additional fantasies. For instance, adding one or more virtual parties into a 2-person explicit video may cost extra.

Therefore, the present invention improves marital relations, encourages safer sex, and can even be used as couples' therapy, such as using sexual videos with the couple's faces superimposed thereon as a sex guide or to learn new sexual techniques. Further, these can be customized based on suggestions or requests submitted by the customer(s).

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A system comprising:
a computer-readable medium;
a logic stored on the computer readable medium, the logic comprising instructions that, when executed by a processor, cause the processor to perform operations comprising:
matching a preexisting video frame with a head shot based on one or more common tags shared by the video frame and the head shot; and
superimposing the head shot on a body within the video frame.

2. The system of claim 1, wherein the head shot is of an individual different than that of an actor associated with the video frame prior to the superimposition.

3. The system of claim 1, wherein the one or more common tags indicates one or more of a camera angle, an exposure, a person, an expression, an utterance, an action, a skin tone, or a character.

4. The system of claim 1, wherein the operations further comprise matching the head shot with the body based on the one or more common tags.

5. The system of claim 1, wherein the operations further comprise incorporating audio of the individual into the video frame.

6. The system of claim 1, wherein the operations further comprise:
calculating a first transition vector comprising a difference between a previous frame and a current frame of video of an individual;
calculating a second transition vector comprising a difference between a previous frame and a current frame of the video of the actor prior to the superimposition; and
selecting at least a portion of video of the individual based, at least in part, on a matching of the first transition vector with the second transition vector.

7. The system of claim 6, wherein the selecting is performed in real time.

8. A method for superimposing a user image onto a video frame, the method comprising:
receiving a user image, wherein the user image is tagged as one or more of a body part or a face;
based on a common tag shared between the use image and the frame, extracting a video frame from a video comprising a plurality of frames; and
superimposing the user image on the frame.

9. The method of claim 8, wherein the user image is of an individual different than that of an actor associated with the frame prior to the superimposition.

10. The method of claim 8, wherein the common tag indicates one or more of a camera angle, an exposure, a person, an expression, an utterance, an action, a skin tone, or a character.

11. The method of claim 8, further comprising matching the head shot with the body based on the one or more common tags.

12. The method of claim 8, further comprising incorporating audio of the individual into the video frame.

13. The method of claim 8, further comprising:
calculating a first transition vector comprising a difference between a previous frame and a current frame of video of an individual;
calculating a second transition vector comprising a difference between a previous frame and a current frame of the video of the actor prior to the superimposition; and
selecting at least a portion of video of the individual based, at least in part, on a matching of the first transition vector with the second transition vector.

14. A non-transitory computer-readable medium configured to store program instructions, which, when executed by a processor, cause the processor to perform operations comprising:
calculating a first transition vector comprising a difference between a previous frame and a current frame of a first video of an actor;
calculating a second transition vector comprising a difference between a previous frame and a current frame of a second video of an individual;
selecting at least a portion of second video based, at least in part, on a matching of the first transition vector with the second transition vector; and
superimposing the selection of at least a portion of the second video onto the first video.

15. The medium of claim 14, wherein the first and second transition vectors are associated with one or more of a group comprising: a displacement, size, and orientation of the actor and the individual, respectively.

16. The medium of claim 14, wherein a subject of the first and second transition vectors is associated with one or more of a group comprising: a camera angle, an exposure, an expression, an utterance, an action, and a skin tone of the actor and the individual, respectively.

17. The medium of claim 14, further comprising incorporating audio of the second video into the first video.

18. The medium of claim 14, wherein the actor is of an individual different than that of an actor associated with the frame prior to the superimposition.

19. The medium of claim 14, wherein the selecting is performed in real time.

20. The medium of claim 19, wherein the real time selecting is performed between each frame of the first video.
